(19) United States
(12) Patent Application Publication
(10) Pub. No.: US 2025/0233360 A1
(43) Pub. Date: Jul. 17, 2025

(54) CONNECTOR

(71) Applicant: YAZAKI CORPORATION, Tokyo (JP)

(72) Inventors: Kimihiro Abe, Makinohara-shi (JP); Motonori Miyanari, Susono-shi (JP); Takuya Otake, Makinohara-shi (JP)

(21) Appl. No.: 19/001,351

(22) Filed: Dec. 24, 2024

(30) Foreign Application Priority Data
Jan. 15, 2024 (JP) 2024-004142

(51) Int. Cl. H01R 13/64; H01R 13/629

(52) U.S. Cl. CPC H01R 13/64; H01R 13/62933

(57) ABSTRACT

A connector includes: a housing to be fitted into a counterpart component; and an fitting assurance component attached to the housing and configured to detect whether the housing is in a fitting position where the housing is fitted to the counterpart component. The housing includes: a lock arm in a cantilever shape; a lock portion provided on the lock arm and configured to engage with the counterpart component in the fitting position; and an operation portion provided on the lock arm and to which an external force is applied for bending the lock arm when releasing the engagement between the lock portion and the counterpart component. When the fitting assurance component is placed In a target attachment position, the fitting assurance component is in contact with the operation portion in a bending direction of the lock arm.

### CROSS-REFERENCE TO RELATED APPLICATION(S)

This application is based upon and claims the benefit of priority from prior Japanese patent application No. 2024-004142 filed on Jan. 15, 2024, the entire contents of which are incorporated herein by reference.

### BACKGROUND

### 1. Field of the Invention

The present disclosure relates to a connector including a housing that can be fitted to a counterpart component and a fitting assurance component (so-called connector position assurance (CPA)) attached to the housing.

### 2. Description of the Related Art

In the related art, a connector has been proposed that has a function of detecting, by using a fitting assurance component (CPA), whether a housing of the connector is in a fitting position where the housing is supposed to be fitted to a counterpart component as designed, and the connector and the counterpart component are properly fitted (hereinafter also referred to as “fitted state”) (see, for example, JP2016-213080A).

The fitting assurance component is generally used in a housing having a lock arm capable of switching between maintaining and releasing the fitted state described above. Specifically, the lock arm and the fitting assurance component are configured such that interference between the fitting assurance component and the lock arm is avoided only in a state where the housing is at the fitting position (that is, the fitted state described above), and the fitting assurance component is attached to a predetermined target attachment position. In other words, when the connector and the counterpart component are not in the fitted state, the fitting assurance component interferes with the lock arm and is not attached to the target attachment position. That is, it is possible to detect whether the connector and the counterpart component are in the fitted state based on whether the fitting assurance component can be attached to such a target attachment position.

In the related art, connectors are generally designed such that a predetermined gap exists between the fitting assurance component and a housing component around the fitting assurance component when the fitting assurance component is at the predetermined target attachment position. This is to reduce frictional forces between the fitting assurance component and the housing component, and to reduce an external force (so-called insertion force) required when placing the fitting assurance component at the target attachment position. However, the existence of such a gap may cause a contact noise when the connector is mounted on a vehicle or the like and actually used, as a result of the fitting assurance component being displaced due to vibration or the like and coming into contact with the housing component. Since such a contact noise can be interpreted as an abnormal noise by a user of the vehicle and the like, it is desirable to reduce occurrence of the contact noise as much as possible. However, as described above, it is generally difficult to achieve both easy attachment of the fitting assurance component to the housing and prevention of unintended displacement (so-called positional deviation) of the fitting assurance component.

### SUMMARY

The present disclosure has been made in view of the above-described circumstances, and an object of the present disclosure is to provide a connector capable of achieving both easy attachment of a fitting assurance component to a housing and prevention of unintended displacement of the fitting assurance component.

In order to achieve the above object, a connector according to the present disclosure is characterized by the following.

According to an aspect of the present disclosure, there is provided a connector including: a housing to be fitted into a counterpart component; and an fitting assurance component attached to the housing and configured to detect whether the housing is in a fitting position where the housing is fitted to the counterpart component, in which the housing includes: a lock arm in a cantilever shape; a lock portion provided on the lock arm and configured to engage with the counterpart component in the fitting position; and an operation portion provided on the lock arm and to which an external force is applied for bending the lock arm when releasing the engagement between the lock portion and the counterpart component, and in which the fitting assurance component detects whether the housing is in the fitting position by being configured such that when the housing is not in the fitting position, the fitting assurance component interferes with the lock portion and is not able to be placed in a target attachment position, and when the housing is in the fitting position, the fitting assurance component is able to be placed in the target attachment position while avoiding interference with the lock portion, and when the fitting assurance component is placed in the target attachment position, the fitting assurance component is in contact with the operation portion in a bending direction of the lock arm.

According to the connector of the present disclosure, when the housing of the connector is at the fitting position where the housing is fitted to the counterpart component (for example, a counterpart connector, a connector mounting port of a counterpart device and the like), the fitting assurance component (that is, CPA) is placed in the predetermined target attachment position, and when the fitting assurance component is not placed in the target attachment position, the fitting assurance component is in contact with the operation portion (so-called finger rest portion) of the lock arm in the bending direction of the lock arm. Therefore, even if an external force such as vibration is applied to the connector, the fitting assurance component is prevented from being displaced (so-called positional deviation) in the bending direction by the operation portion which is in contact with the fitting assurance component. Accordingly, it is possible to reduce the generation of contact noise as compared with a connector in the related art. Further, since the operation portion is provided on the lock arm, the operation portion can be elastically displaced in the bending direction of the lock arm.

Accordingly, no excessive external force (that is, the insertion force) is required when the fitting assurance component is placed in the target attachment position as compared with a case where the fitting assurance component comes into contact with a member for which displacement is not anticipated in the design (for example, a wall portion of the housing or the like). Therefore, the connector according to the present disclosure can achieve both easy attachment of the fitting assurance component to the housing and prevention of unintended displacement of the fitting assurance component.

Further, as another effect, since the operation portion of the lock arm is in contact with the fitting assurance component, not only the displacement of the fitting assurance component but also the displacement of the operation portion are prevented, so that it is possible to prevent unintentional displacement of the operation portion that would result in a reduction in the engagement allowance between the lock portion and the counterpart component. That is, a decrease in the engagement force is prevented. Thus, according to the connector of the present disclosure, the fitted state between the connector and the counterpart component can be properly maintained.

The present disclosure has been briefly described above. Further, details of the present disclosure will be further clarified by reading modes for carrying out the invention described below with reference to the accompanying drawings.

### BRIEF DESCRIPTION OF DRAWINGS

The present disclosure will become more fully understood from the detailed description given hereinbelow and the accompanying drawing which is given by way of illustration only, and thus is not limitative of the present disclosure and wherein:

FIG. 1 is a perspective view showing a connector according to an embodiment of the present disclosure and a counterpart connector;

FIG. 2 is an exploded perspective view of the connector shown in FIG. 1;

FIG. 3 is a front view of a female housing shown in FIG. 2;

FIG. 4 is a perspective view of a fitting assurance component (CPA) shown in FIG. 2;

FIG. 5 is a cross-sectional view corresponding to a cross section taken along a line A-A of FIG. 1, showing a state in which the connector and the counterpart connector are in an unfitted state and the fitting assurance component (CPA) is in an initial position;

FIG. 6 is a cross-sectional view corresponding to the cross section taken along the line A-A of FIG. 1, showing a state in which the connector and the counterpart connector are in a fitted state and the fitting assurance component (CPA) is in a target attachment position;

FIG. 7 is an enlarged view of a part B in FIG. 6; and

FIG. 8 is a cross-sectional view taken along a line C-C of FIG. 7.

### DETAILED DESCRIPTION OF THE INVENTION

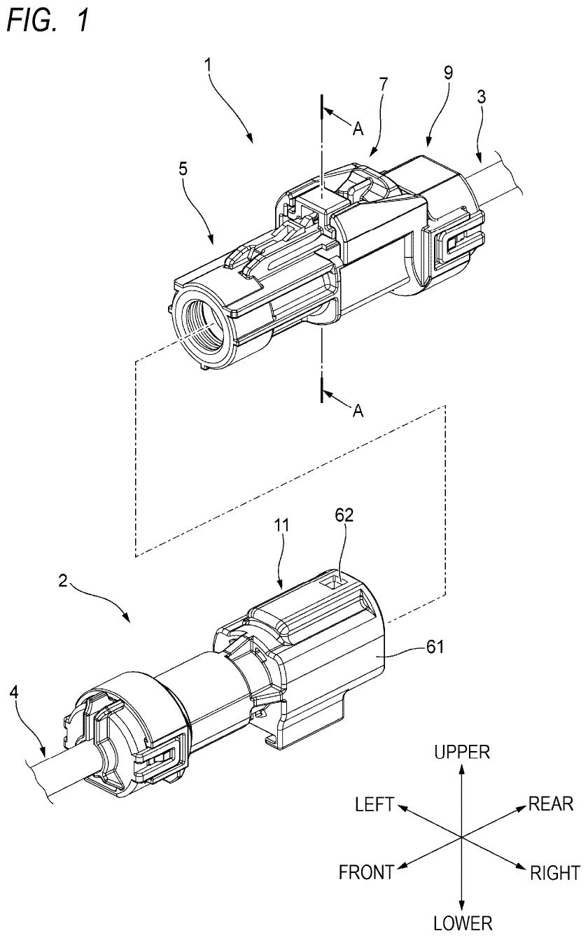

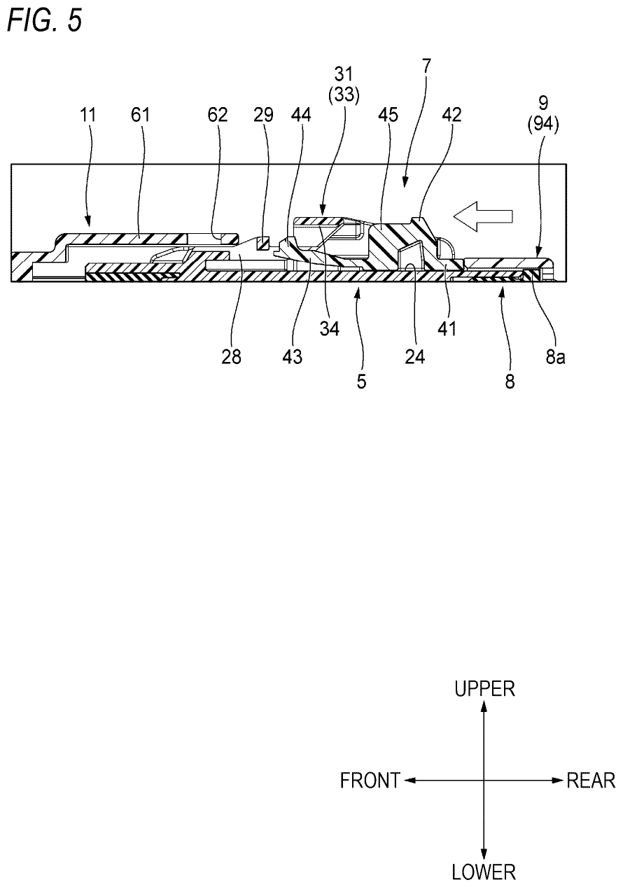

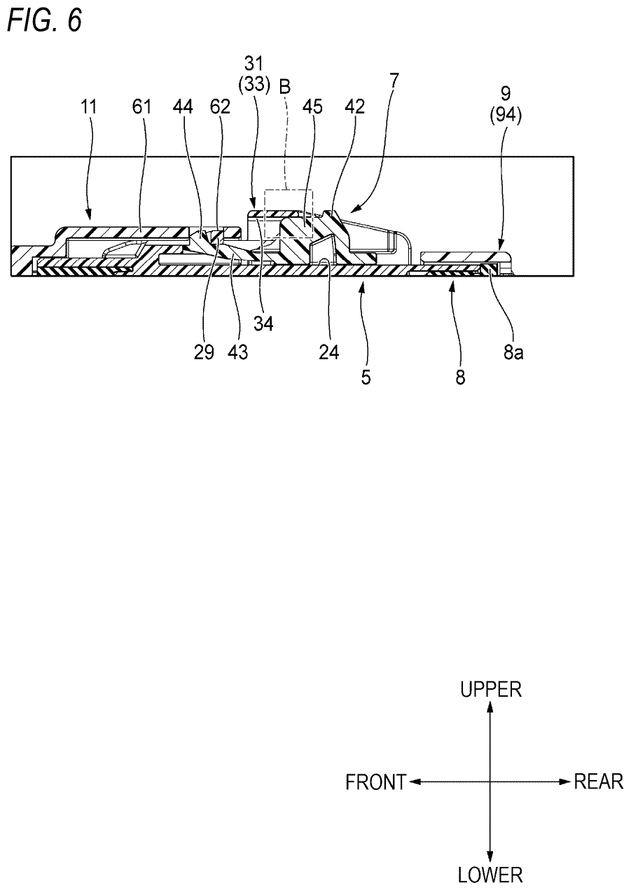

Hereinafter, a connector 1 according to an embodiment of the present disclosure will be described with reference to the drawings. The connector 1 (see FIG. 1) is a female connector connected to an electric wire 3. A counterpart connector 2 (see FIG. 1) is a male connector connected to an electric wire 4. As shown in FIGS. 5 and 6, a female housing 5 (see FIG. 1) of the connector 1 can be fitted to a male housing 11 (see FIG. 1) of the counterpart connector 2. The female housing 5 corresponds to the “housing” in the present disclosure, and the male housing 11 corresponds to the “counterpart component” in the present disclosure. In the embodiment, the connector 1 is to be fitted to the counterpart connector 2, but the connector 1 may be fitted to another counterpart component (for example, a connector attachment port of a counterpart device).

Hereinafter, for convenience of description, “front”, “rear”, “left”, “right”, “upper”, and “lower” are defined as illustrated in FIG. 1 and the like. A “front-rear direction”, a “left-right direction”, and an “upper-lower direction” are orthogonal to one another. The front-rear direction coincides with a fitting direction of the connector 1 and the counterpart connector 2. For the connector 1, a front surface side in the fitting direction in which the counterpart connector 2 is fitted is referred to as a front side, and a back surface side in the fitting direction opposite thereto is referred to as a rear side.

When the female housing 5 and the male housing 11 are fitted to each other, the female housing 5 and the male housing 11 go through a state in which they are halfway fitted (see FIG. 5), and then reach a state in which the female housing 5 and the male housing 11 are completely fitted with each other (see FIG. 6). Hereinafter, for convenience of description, the former state is referred to as the “unfitted state”, and the latter state is referred to as the “fitted state”.

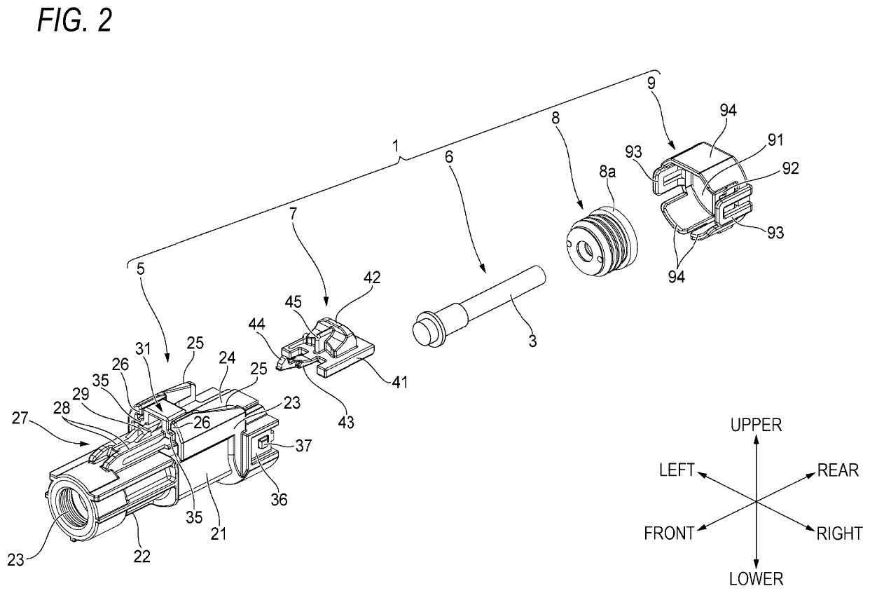

First, the connector 1 will be described with reference to FIGS. 1 to 4. As shown in FIG. 2, the connector 1 includes the female housing 5, a terminal module 6 accommodated in the female housing 5, a fitting assurance component 7 provided to be movable in the front-rear direction on an upper portion of the female housing 5, a packing 8 closing a gap between the female housing 5 and the electric wire 3 extending from the terminal module 6, and a cover 9 provided on the female housing 5 to cover a rear end surface of the packing 8. Hereinafter, configuration of each component that forms the connector 1 will be described below in order. In the following description, the “fitting assurance component” is abbreviated as “CPA”.

First, the female housing 5 will be described. As shown in FIG. 2, the female housing made of resin integrally includes a rectangular tubular portion 21 having a substantially rectangular tubular shape and a cylindrical portion 22 having a substantially cylindrical shape and located in front of the rectangular tubular portion 21, and has a shape extending in the front-rear direction. The cylindrical portion 22 of the female housing 5 is inserted into a fitting recessed portion defined inside a hood portion 61 (see FIG. 1) of the male housing 11 of the counterpart connector 2, so that the female housing 5 and the male housing 11 are fitted together (see FIG. 6).

As shown in FIG. 2 and the like, a terminal accommodating chamber 23 penetrating in the front-rear direction is formed inside the female housing 5 so as to extend in the front-rear direction. The terminal module 6 is accommodated in the terminal accommodating chamber 23. The terminal module 6 is a female terminal having a shape extending in the front-rear direction, and the electric wire 3 is connected to a rear end portion of the terminal module 6 so as to extend rearward. When the female housing 5 and the male housing 11 are fitted to each other, a male terminal (not shown) accommodated in the male housing 11 and connected to the electric wire 4 (see FIG. 1) is inserted into a front end portion of the terminal accommodating chamber 23.

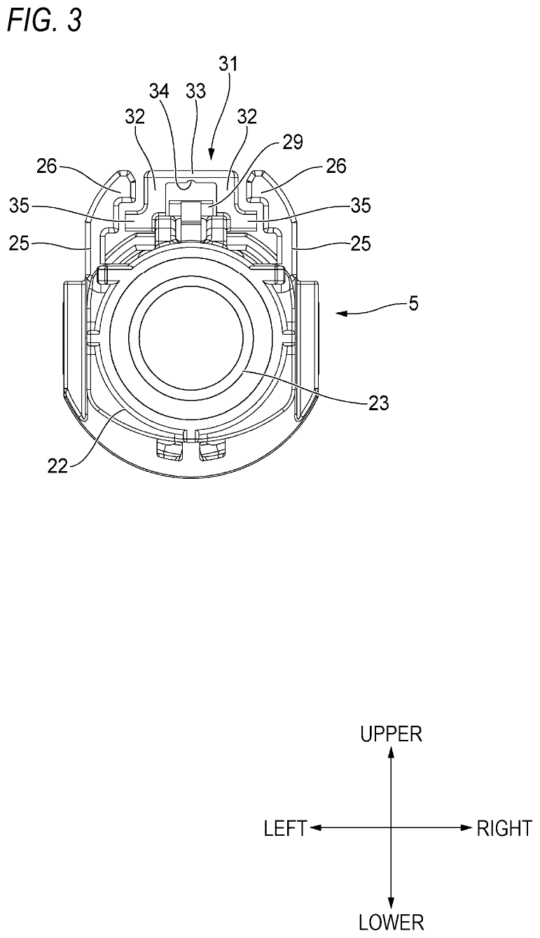

As shown in FIG. 2, on both left and right end portions of an upper wall 24 of the female housing 5 (more specifically, the rectangular tubular portion 21), a pair of ribs 25 rising upward are integrally provided so as to extend in a front region of the rectangular tubular portion 21 and to face each other in the left-right direction. A space between by the pair of ribs 25 functions as a space (so-called slide space) for accommodating the CPA 7 and guiding the CPA 7 in the front-rear direction. The pair of ribs 25 serve to guide the CPA 7 in the front-rear direction as it moves in the front-rear direction on the upper wall 24 of the rectangular tubular portion 21. A pair of protruding portions 26 protruding inward in the left-right direction and facing each other in the left-right direction are integrally formed at upper end portions of front regions of the pair of ribs 25 (see FIGS. 2 and 3).

As shown in FIG. 2, a locking mechanism 27 is provided on the upper portion of the female housing 5 (more specifically, the cylindrical portion 22). The locking mechanism 27 has a function of switching between maintaining and releasing the fitted state of the female housing and the male housing 11 by engaging with a locked hole 62 (see FIG. 1) provided in an upper portion of the hood portion 61 of the male housing 11 of the counterpart connector 2.

As shown in FIG. 2, the locking mechanism 27 includes a pair of lock arms 28 extending rearward in a cantilever shape from a front end portion of an upper portion of the cylindrical portion 22 of the female housing 5 at a distance in the left-right direction. The pair of lock arms 28 are elastically deformable in the upper-lower direction, and extend to a position above a front end portion of the upper wall 24 of the rectangular tubular portion 21 of the female housing 5.

The pair of lock arms 28 are integrally formed with a lock protrusion 29 that couples, in the left-right direction, intermediate portions of the lock arms 28 in the front-rear direction, and an operation portion 31 that couples tip end portions (rear end portions) of the lock arms 28 in the left-right direction. Specifically, as shown in FIG. 3, the operation portion 31 includes a pair of vertical wall portions 32 protruding upward from the tip end portions of the pair of lock arms 28, and a top plate portion 33 having a substantially rectangular flat plate shape that couples the pair of vertical wall portions 32 in the left-right direction. A recessed portion 34 is formed in a central portion in the left-right direction of a lower face of the top plate portion 33. The recessed portion 34 is recessed upward and extends in the front-rear direction. The effect of forming the recessed portion 34 will be described later.

The operation portion 31 is located above the front end portion of the upper wall of the rectangular tubular portion 21, and a dimension of the operation portion 31 in the left-right direction is smaller than a distance between the pair of protruding portions 26 in the left-right direction. Therefore, as the pair of lock arms 28 are elastically deformed in the upper-lower direction, the operation portion 31 can move in the upper-lower direction in a space between the pair of protruding portions 26 provided on the pair of ribs 25.

The locked hole 62 of the male housing 11 is engaged with the lock protrusion 29 of the locking mechanism 27, thereby maintaining the fitted state between the female housing 5 and the male housing 11 (see FIG. 6). In this fitted state, by pushing the operation portion 31 downward, the lock protrusion 29 moves downward, the engagement between the lock protrusion 29 and the locked hole 62 is released, and the female housing 5 and the male housing 11 can be separated in the front-rear direction.

A pair of protruding portions 35 protruding outward in the left-right direction are integrally formed on the tip end portions of the pair of lock arms 28 (that is, lower portions of the operation portion 31) (see FIG. 3 and the like). The pair of protruding portions 35 interfere with the pair of protruding portions 26 in the upper-lower direction when the pair of lock arms 28 are elastically deformed upward, thereby preventing the pair of lock arms 28 from being excessively deformed upward.

As shown in FIG. 2, a pair of left and right grooves 36 are formed on outer peripheral surfaces of both end portions in the left-right direction of a rear end portion of the female housing 5. The grooves 36 are recessed inward in the left-right direction and extend forward from the rear end of the female housing 5. An engagement protrusion 37 protruding outward in the left-right direction is formed on a bottom surface of each groove 36. A pair of engagement frame body portions 93 of the cover 9, which will be described later, are inserted into the pair of grooves 36.

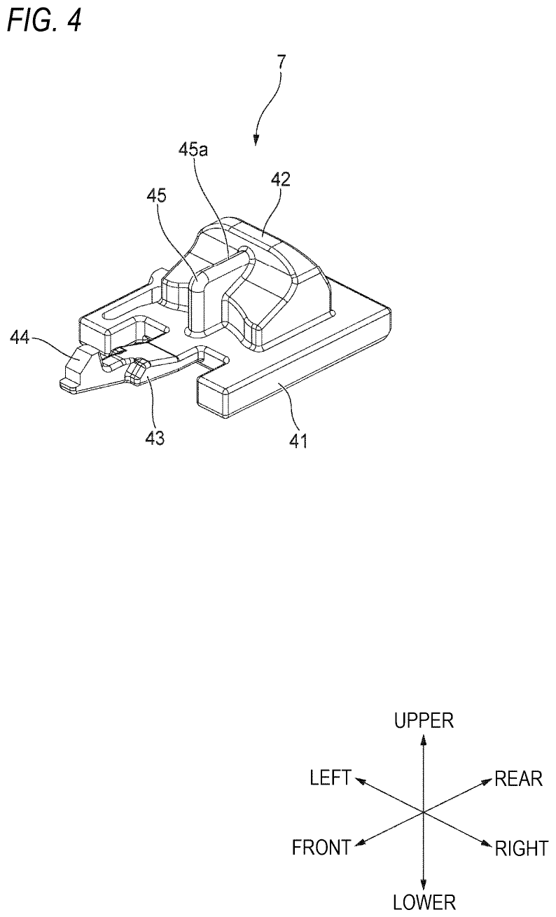

Next, the CPA 7 will be described. The resin CPA 7 shown in FIGS. 2 and 4 is provided to be movable in the front-rear direction on the upper wall 24 of the rectangular tubular portion 21 of the female housing 5. The CPA 7 has a body portion 41 in the shape of a generally rectangular flat plate extending in the front-rear direction. A CPA operation portion 42 that protrudes upward and extends in the left-right direction is provided at an upper rear portion of the body portion 41. A dimension of the body portion 41 in the left-right direction is smaller than a distance between the pair of ribs 25 in the left-right direction. Accordingly, the body portion 41 is movable in the front-rear direction in a space between the pair of ribs 25 while being guided by the pair of ribs 25.

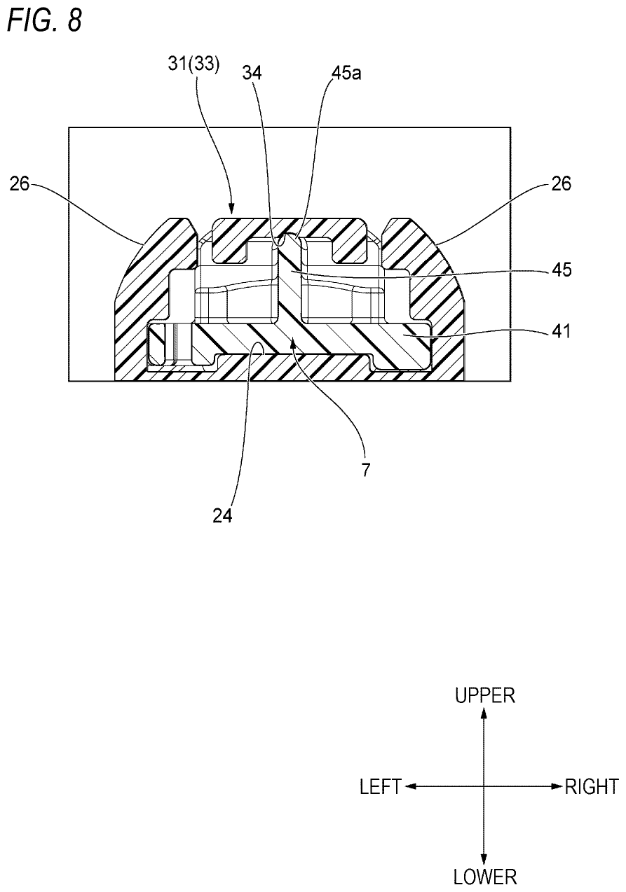

The body portion 41 is integrally formed with an arm portion 43 that extends forward from a central portion in the left-right direction of a front surface of the body portion 41. A protrusion 44 that engages with the lock protrusion 29 of the locking mechanism 27 is formed at a tip end portion (that is, a front end portion) of the arm portion 43 so as to protrude upward. A dimension of the arm portion 43 in the left-right direction is smaller than a dimension of the body portion 41 in the left-right direction. A flat plate-shaped protruding portion 45 that protrudes upward and extends forward from the CPA operation portion 42 is formed at a central portion in the left-right direction of an upper face of the body portion 41. An upper end surface of the protruding portion 45 extending in the front-rear direction is a convex portion 45a having a convex shape protruding upward (see FIGS. 4 and 8). The effect of forming the protruding portion 45 will be described later.

As shown in FIG. 5, in the unfitted state (the state of the connector 1 alone) before the fitting of the connector 1 and the counterpart connector 2, the CPA 7 is disposed at the initial position shown in FIG. 5 on the upper wall 24 of the rectangular tubular portion 21 of the female housing 5. Then, in the space between the pair of ribs 25 of the female housing 5, the CPA 7 is moved forward by pressing the CPA operation portion 42 forward while the CPA 7 (the body portion 41) is guided by the pair of ribs 25. Such forward movement of the CPA 7 continues until the protrusion 44 located at the tip end of the arm portion 43 of the CPA 7 engages with a rear surface of the lock protrusion 29 of the locking mechanism 27 of the female housing 5. When the protrusion 44 of the CPA 7 engages with the rear surface of the lock protrusion 29 of the female housing 5, the CPA 7 cannot move forward than the position. That is, in the unfitted state, the CPA 7 cannot be moved to the target attachment position (see FIG. 6) shown in FIG. 6.

Next, the packing 8 and the cover 9 will be described. The rubber packing 8 is a member disposed in a gap between an outer surface of the electric wire 3 extending from the terminal module 6 and an inner surface of a rear end opening of the terminal accommodating chamber 23 of the female housing 5. The packing 8 seals the gap so as to provide a waterproof function of preventing water from entering the terminal accommodating chamber 23 from the outside. As shown in FIG. 2, the packing 8 has a generally cylindrical shape extending in the front-rear direction. A rear end portion of the packing 8 has an annular flange portion 8a that protrudes radially outward. An outer peripheral shape of the packing 8 corresponds to a shape of the inner surface of the rear end opening of the terminal accommodating chamber 23, and an inner peripheral shape of the packing 8 corresponds to a shape of the outer surface of the electric wire 3.

The resin cover 9 is a member to be assembled to the rear end portion of the female housing 5 so as to cover the rear end surface of the packing 8. The cover 9 serves to prevent the packing 8 from falling off (separating) from the female housing 5 and to prevent positional deviation of the electric wire 3 extending from the terminal module 6. As shown in FIG. 2, the cover 9 has a flat plate-shaped lid wall portion 91 disposed to close the rear end opening of the terminal accommodating chamber 23 of the female housing 5. An outer peripheral shape of the lid wall portion 91 corresponds to the shape of the rear end opening of the terminal accommodating chamber 23 of the female housing 5.

A through hole 92, through which the electric wire 3 extending in the front-rear direction is inserted, is formed in a central portion of the lid wall portion 91. The pair of left and right engagement frame body portions 93 are integrally formed on both end portions in the left-right direction of the lid wall portion 91 so as to protrude forward. Each engagement frame body portion 93 is elastically deformable in the left-right direction. Peripheral walls 94 are integrally formed on outer peripheral edges of the lid wall portion 91 located above and below the pair of engagement frame body portions 93 so as to protrude forward and extend along the outer peripheral edges of the lid wall portion 91.

The packing 8 and the cover 9 are assembled to the female housing 5 as follows. First, one end portion of the electric wire 3 is inserted into the through hole 92 of the cover 9 and the through hole of the packing 8. Next, the one end portion of the electric wire 3 is connected to the rear end portion of the terminal module 6. Next, the terminal module 6 to which the electric wire 3 is connected is accommodated in the terminal accommodating chamber 23 from the rear side through the rear end opening of the terminal accommodating chamber 23 of the female housing 5. Next, the packing 8 through which the electric wire 3 is inserted is disposed in the gap between the inner surface of the rear end opening of the terminal accommodating chamber 23 and the outer surface of the electric wire 3 in a state where the flange portion 8a is in contact with a rear end surface of the female housing 5 through the rear end opening of the terminal accommodating chamber 23 of the female housing 5 (see also FIGS. 5 and 6). As a result, an outer peripheral surface and an inner peripheral surface of the packing 8 are in close contact with the inner surface of the rear end opening of the terminal accommodating chamber 23 and the outer surface of the electric wire 3, respectively, so that the above-described waterproof function of the packing 8 is achieved.

Next, the cover 9 through which the electric wire 3 is inserted is attached to the rear end portion of the female housing 5. In the state where the cover 9 is completely attached to the rear end portion of the female housing 5, the pair of engagement frame body portions 93 of the cover 9 are inserted into the pair of grooves 36 of the female housing 5, hole edges at a front end portion of the pair of engagement frame body portions 93 are engaged with the pair of engagement protrusions 37, and the peripheral wall 94 of the cover 9 engages with the rear end portion of the female housing 5 in a manner of covering the outer peripheral surface of the rear end portion of the female housing 5 or being accommodated in an accommodation groove (not shown) formed in the rear end surface of the female housing 5. The engagement between the hole edges of the pair of engagement frame body portions 93 and the pair of engagement protrusions 37 prevents the cover 9 (and further the packing 8) from falling off (separating) from the female housing 5. Further, in the embodiment, since the peripheral wall 94 on the upper side of the cover 9 is disposed to cover a rear end portion of the upper wall 24 of the female housing 5 (see FIGS. 1 and 5), the CPA 7 disposed on the upper wall 24 of the female housing 5 is prevented from moving (falling off) backward (see FIG. 5). Further, even if an external force in a direction intersecting an axial direction of the electric wire 3 is applied to the electric wire 3 extending to the outside of the female housing 5 through the through hole 92 of the cover 9, the positional deviation of the electric wire 3 is prevented by a hole wall of the through hole 92. As a result, deformation of the packing 8 caused by the positional deviation of the electric wire 3 is prevented, so that deterioration in the waterproof function of the packing 8 caused by the deformation of the packing 8 is reduced. The connector 1 has been described above.

Hereinafter, an operation of fitting the connector 1 to the counterpart connector 2 will be described. As shown in FIGS. 5 and 6, the connector 1 connected to the electric wire 3 and having the CPA 7 locked at the initial position is fitted to the counterpart connector 2. The fitting operation is performed such that the cylindrical portion 22 of the female housing 5 is inserted into the fitting recessed portion in the hood portion 61 of the male housing 11, and the terminal module 6 (female terminal) accommodated in the female housing 5 and connected to the electric wire 3 is connected to the male terminal accommodated in the male housing 11 and connected to the electric wire 4. The fitting operation is continued until the locked hole 62 of the male housing 11 engages with the lock protrusion 29 of the locking mechanism 27 of the female housing 5.

A hole edge of the locked hole 62 passes over an upper portion of the lock protrusion 29 of the locking mechanism 27 that is temporarily elastically deformed downward due to the pressure from the hole edge of the locked hole 62, and moves to the rear side of the lock protrusion 29 of the locking mechanism 27 that has elastically returned, so that the locked hole 62 and the lock protrusion 29 are engaged with each other (see FIG. 6). Thus, the female housing and the male housing 11 are maintained in the fitted state.

Further, when the hole edge of the locked hole 62 moves to the rear side of the lock protrusion 29, the protrusion 44 of the CPA 7 positioned at the rear side of the lock protrusion 29 is pushed down by the hole edge of the locked hole 62, so that the arm portion 43 of the CPA 7 is elastically deformed downward, and the engagement between the protrusion 44 and the lock protrusion 29 is released. That is, the CPA 7 can move to the target attachment position in the front (see FIG. 6). In this state, the CPA 7 (CPA operation portion 42) is pushed forward, so that the CPA 7 moves to the target attachment position shown in FIG. 6 while the arm portion 43 is kept elastically deformed downward. When the CPA 7 reaches the target attachment position, the protrusion 44 passes over a lower portion of the lock protrusion 29 and the arm portion 43 elastically returns, so that the protrusion 44 moves to the front side of the lock protrusion 29. Thus, the CPA 7 is locked to the target attachment position.

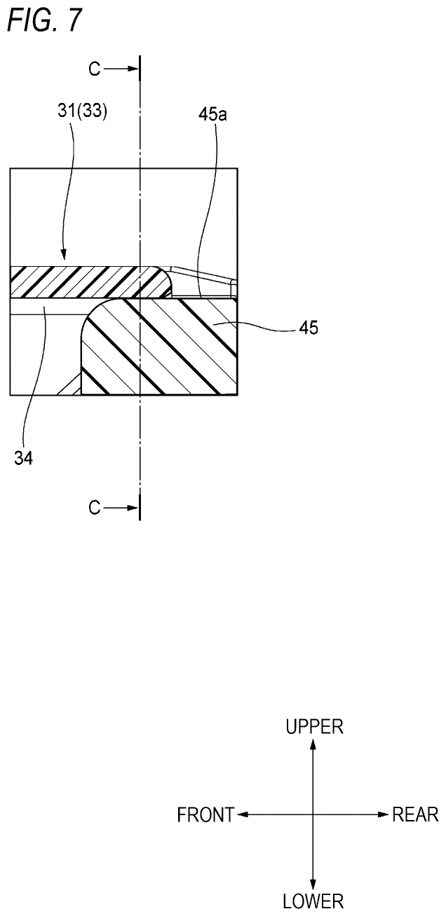

When the CPA 7 moves from the initial position to the target attachment position, the convex portion 45a, which is the upper end surface of the protruding portion 45 provided on the CPA 7, pushes the recessed portion 34, which is provided on the lower face of the top plate portion 33 of the operation portion 31 of the locking mechanism 27, slightly upward and advances forward while sliding against the recessed portion 34 (see FIGS. 6 to 8). When the CPA 7 is at the target attachment position, a state in which the recessed portion 34 and the convex portion 45a are in pressing contact with each other (that is, a state in which the CPA 7 is vertically pressed and clamped between the operation portion 31 and the upper wall 24 of the female housing 5) is maintained by an elastic restoring force of the lock arm 28 that is elastically deformed slightly upward. Accordingly, even if an external force such as vibration is applied to the connector 1, the CPA 7 is prevented from being displaced in the upper-lower direction relative to the female housing 5 by the operation portion 31 which is in pressing contact with the CPA 7.

Further, the operation portion 31 provided on the lock arm 28 is elastically displaceable in a bending direction (that is, the upper-lower direction) of the lock arm 28. Accordingly, a sliding frictional force when the CPA 7 pushes away the operation portion 31 and slides is smaller than that when a counterpart member against which the CPA 7 slides is a member that cannot be displaced in the upper-lower direction. Therefore, when pushing the CPA 7 from the initial position forward toward the target attachment position, no excessive external force (insertion force) is required. Since the convex portion 45a of the protruding portion 45 comes into contact with the operation portion 31, a contact area between the CPA 7 and the operation portion 31 can be reduced, and thus the insertion force of the CPA 7 can be further reduced.

In addition, in a state in which the CPA 7 is at the target attachment position, the recessed portion 34 of the operation portion 31 and the convex portion 45a of the protruding portion 45 are in pressing contact with each other. Accordingly, the recessed portion 34 and the convex portion 45a are engaged with each other in the left-right direction as well, so that not only the displacement of the CPA 7 in the upper-lower direction but also the displacement of the CPA 7 in the left-right direction is prevented. Accordingly, the positional deviation of the CPA 7 with respect to the female housing 5 can be further effectively reduced.

When the CPA 7 is at the target attachment position, the CPA 7 serves to ensure that the female housing 5 and the male housing 11 are in the fitted state. Further, in a state in which the CPA 7 is at the target attachment position, as shown in FIG. 6, the protruding portion 45 of the CPA 7 is in contact with the operation portion 31 of the locking mechanism 27, so that the operation portion 31 cannot move downward. This prevents the operation portion 31 from unintentionally moving downward and reducing an engagement allowance between the lock protrusion 29 and the locked hole 62. That is, a decrease in the engagement force is prevented. Thus, the CPA 7 also serves to prevent the release of the engagement between the lock protrusion 29 and the locked hole 62 caused by the downward elastic deformation of the locking mechanism 27 (so-called double locking function).

On the other hand, when the female housing 5 and the male housing 11 are in the unfitted state, the hole edge of the locked hole 62 of the male housing 11 does not push the protrusion 44 of the CPA 7 downward, so that the engagement between the protrusion 44 and the lock protrusion 29 is not released. Therefore, the CPA 7 cannot move to the target attachment position. In this way, since the CPA 7 cannot move to the target attachment position, the unfitted state between the female housing 5 and the male housing 11 can be easily detected. The operation of fitting the connector 1 to the counterpart connector 2 has been described above.

In the fitted state of the female housing 5 and the male housing 11, the terminal module 6 accommodated in the female housing 5 and the male terminal accommodated in the male housing 11 are electrically connected. Thus, the electric wire 3 connected to the terminal module 6 and extending from the female housing 5 and the electric wire 4 connected to the male terminal and extending from the male housing 11 are electrically connected.

Next, an operation for separating the female housing 5 and the male housing 11 from a state shown in FIG. 6 (a state where the female housing 5 and the male housing 11 are in the fitted state and the CPA 7 is at the target attachment position) for maintenance or the like will be described.

In order to separate the female housing 5 and the male housing 11, first, the CPA 7 is returned from the target attachment position to the initial position by pulling the CPA operation portion 42 of the CPA 7 backward. Next, the operation portion 31 of the locking mechanism 27 is pushed downward into the space between the pair of ribs 25. Thus, the lock protrusion 29 of the locking mechanism 27 elastically deformed downward moves downward. As a result, the engagement between the lock protrusion 29 and the locked hole 62 is released, and the female housing 5 and the male housing 11 can be separated in the front-rear direction. Therefore, the female housing 5 and the male housing 11 can be separated from each other.

### Operations and Effects

As described above, according to the connector 1 of the present embodiment, when the connector 1 is fitted to the counterpart connector 2 and turns into the fitted state, the fitting assurance component (CPA) 7 is disposed at the target attachment position, and when the CPA 7 is disposed at the target attachment position, the CPA 7 is maintained in contact with the operation portion 31 of the lock arm 28 in the bending direction of the lock arm 28. Therefore, even if an external force such as vibration is applied to the connector 1 in the fitted state, the CPA 7 is prevented from being displaced in the bending direction by the operation portion 31 which is in contact with the CPA 7. Accordingly, it is possible to reduce the generation of contact noise (in other words, abnormal noise) as compared with a connector in the related art. Further, since the operation portion 31 is provided on the lock arm 28, the operation portion 31 can be elastically displaced in the bending direction of the lock arm 28. Accordingly, when the CPA 7 is disposed at the target attachment position, no excessive external force (insertion force) is required as compared with a case in which the operation portion is a non-displaceable member. Therefore, the connector 1 according to the present embodiment can achieve both easy attachment of the CPA 7 to the female housing 5 and prevention of the positional deviation of the CPA 7.

Further, when the CPA 7 is disposed at the target attachment position, the protruding portion 45 provided on the CPA 7 comes into contact with the operation portion 31. Accordingly, the contact area between the CPA 7 and the operation portion 31 can be reduced, so that the insertion force of the CPA 7 can be further reduced. Even when the protruding portion 45 of the CPA 7 is in contact with the operation portion 31, the effect of preventing the displacement of the CPA 7 is not impaired.

Further, the convex portion 45a of the CPA 7 is fitted into the recessed portion 34 of the operation portion 31 at a contact point where the CPA 7 and the operation portion 31 are in contact with each other. Accordingly, not only the displacement of the CPA 7 in the bending direction of the lock arm 28 but also displacement of the CPA 7 in a direction different from the bending direction (the upper-lower direction) of the lock arm 28 (for example, a left-right direction in which an inner surface of the recessed portion 34 and the convex portion 45a engage) is also prevented. Accordingly, the positional deviation of the CPA 7 can be prevented more effectively.

### Other Embodiments

The present disclosure is not limited to the embodiment described above and various modifications can be adopted within the scope of the present disclosure. For example, the disclosure is not limited to the embodiment described above, and modifications, improvements, and the like can be made appropriately. In addition, materials, shapes, sizes, numbers, arrangement positions, or the like of components in the above-described embodiment are freely selected and are not limited as long as the present disclosure can be implemented.

For example, in the above-described embodiment, at the contact point where the CPA 7 and the operation portion 31 are in contact with each other, the convex portion 45a of the CPA 7 is fitted into the recessed portion 34 of the operation portion 31, and the convex portion 45a is brought into contact with the recessed portion 34. Alternatively, at the contact point where the CPA 7 and the operation portion 31 are in contact with each other, a convex portion of the operation portion 31 may be fitted into a recessed portion of the CPA 7, and the convex portion may be brought into contact with the recessed portion.

Here, features of the embodiment of the connector 1 according to the present disclosure described above are briefly summarized and listed in the following [1] to [3].

[1] A connector (1) including:
a housing (5) to be fitted into a counterpart component (11); and
an fitting assurance component (7) attached to the housing (5) and configured to detect whether the housing (5) is in a fitting position where the housing (5) is fitted to the counterpart component (11),
in which the housing (5) includes
a lock arm (28) in a cantilever shape,
a lock portion (29) provided on the lock arm (28) and configured to engage with the counterpart component (11) in the fitting position, and
an operation portion (31) provided on the lock arm (28) and to which an external force is applied for bending the lock arm (28) when releasing the engagement between the lock portion (29) and the counterpart component (11), and
in which the fitting assurance component (7) detects whether the housing (5) is in the fitting position by being configured such that when the housing (5) is not in the fitting position, the fitting assurance component (7) interferes with the lock portion (29) and is not able to be placed in the target attachment position, and when the housing (5) is in the fitting position, the fitting assurance component (7) is able to be placed in the target attachment position while avoiding interference with the lock portion (29), and when the fitting assurance component (7) is placed in the target attachment position, the fitting assurance component (7) is in contact with the operation portion (31) in a bending direction of the lock arm (28).

According to the connector having the configuration of the above [1], when the housing of the connector is at the fitting position where the housing is fitted to the counterpart component (for example, a counterpart connector, a connector mounting port of a counterpart device and the like), the fitting assurance component (that is, CPA) is placed in the predetermined target attachment position, and when the fitting assurance component is not placed in the target attachment position, the fitting assurance component is maintained in contact with the operation portion (so-called finger rest portion) of the lock arm in the bending direction of the lock arm. Therefore, even if an external force such as vibration is applied to the connector, the fitting assurance component is prevented from being displaced (so-called positional deviation) in the bending direction by the operation portion which is in contact with the fitting assurance component. Accordingly, it is possible to reduce the generation of contact noise as compared with a connector in the related art. Further, since the operation portion is provided on the lock arm, the operation portion can be elastically displaced in the bending direction of the lock arm. Accordingly, no excessive external force (that is, the insertion force) is required when the fitting assurance component is placed in the target attachment position as compared with a case where the fitting assurance component comes into contact with a member for which displacement is not anticipated in the design (for example, a wall portion of the housing or the like). Therefore, the connector according to the present configuration can achieve both easy attachment of the fitting assurance component to the housing and prevention of unintended displacement of the fitting assurance component.

Further, as another effect, by maintaining the state in which the operation portion of the lock arm and the fitting assurance component are in contact with each other, not only the displacement of the fitting assurance component but also the displacement of the operation portion are prevented, so that it is possible to prevent unintentional displacement of the operation portion that would result in a reduction in the engagement allowance between the lock portion and the counterpart component. That is, a decrease in the engagement force is prevented. Thus, according to the connector of the present configuration, the fitted state between the connector and the counterpart component can be properly maintained.

[2] In the connector (1) according to the above [1],
the fitting assurance component (7) includes a protruding portion (45) having a shape that protrudes toward the operation portion (31) when the fitting assurance component (7) is placed in the target attachment position, and
the protruding portion (45) comes into contact with the operation portion (31) when the fitting assurance component (7) is placed in the target attachment position.

According to the connector having the configuration of [2], when the fitting assurance component is placed in the target attachment position, the state in which the protruding portion provided in the fitting assurance component is in contact with the operation portion is maintained. Accordingly, the contact area between the fitting assurance component and the operation portion can be reduced, so that the insertion force of the fitting assurance component can be further reduced. As can be understood from the above description, even when the protruding portion of the fitting assurance component is in contact with the operation portion, the effect of preventing the displacement of the fitting assurance component is not impaired.

[3] In the connector (1) according to the above [1],
at a contact point where the fitting assurance component (7) and the operation portion (31) are in contact with each other, a convex portion (45a) of one of the fitting assurance component (7) and the operation portion (31) is fitted in a recessed portion (34) of the other of the fitting assurance component (7) and the operation portion (31).

According to the connector having the configuration of the above [3], at a contact point where the fitting assurance component and the operation portion are in contact with each other, the convex portion of one of the fitting assurance component and the operation portion is fitted in the recessed portion of the other of the fitting assurance component and the operation portion. Accordingly, not only the displacement of the fitting assurance component in the bending direction of the lock arm but also the displacement of the fitting assurance component in a direction different from the bending direction of the lock arm (for example, a direction in which an inner surface of the recessed portion and an outer surface of the convex portion are engaged) is also prevented. Accordingly, the positional deviation of the fitting assurance component can be prevented more effectively.

1. A connector comprising:
a housing to be fitted into a counterpart component; and
an fitting assurance component attached to the housing and configured to detect whether the housing is in a fitting position where the housing is fitted to the counterpart component,
wherein the housing includes:
a lock arm in a cantilever shape;
a lock portion provided on the lock arm and configured to engage with the counterpart component in the fitting position; and
an operation portion provided on the lock arm and to which an external force is applied for bending the lock arm when releasing the engagement between the lock portion and the counterpart component, and
wherein the fitting assurance component detects whether the housing is in the fitting position by being configured such that when the housing is not in the fitting position, the fitting assurance component interferes with the lock portion and is not able to be placed in a target attachment position, and when the housing is in the fitting position, the fitting assurance component is able to be placed in the target attachment position while avoiding interference with the lock portion, and when the fitting assurance component is placed in the target attachment position, the fitting assurance component is in contact with the operation portion in a bending direction of the lock arm.

2. The connector according to claim 1,
wherein the fitting assurance component includes a protruding portion having a shape that protrudes toward the operation portion when the fitting assurance component is placed in the target attachment position, and
wherein the protruding portion comes into contact with the operation portion when the fitting assurance component is placed in the target attachment position.

3. The connector according to claim 1,
wherein at a contact point where the fitting assurance component and the operation portion are in contact with each other, a convex portion of one of the fitting assurance component and the operation portion is fitted in a recessed portion of the other of the fitting assurance component and the operation portion.
